(19) United States
(12) Patent Application Publication
(10) Pub. No.: US 2007/0229738 A1
(43) Pub. Date: Oct. 4, 2007

(54) LIQUID CRYSTAL DISPLAY PANEL

(76) Inventors: Kenji Nakao, Kanazawa-shi (JP); Hirofumi Wakemoto, Kanazawa-shi (JP); Nami Uyama, Hakusan-shi (JP); Yasuyuki Tsuji, Kanazawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/693,178

(22) Filed: Mar. 29, 2007

(30) Foreign Application Priority Data
Mar. 31, 2006 (JP) 2006-100026

(51) Int. Cl. G02F 1/1335

(52) U.S. Cl. 349/117

(57) ABSTRACT

A liquid crystal display panel includes an array substrate, a counter-substrate, a liquid crystal layer which is held between the array substrate and the counter-substrate and contains liquid crystal molecules whose alignment state is to be transitioned to a bend alignment for enabling a display operation, a retardation plate which is disposed at least on the counter-substrate, and a polarizer which is disposed on the retardation plate. The array substrate and counter-substrate include a pair of electrodes which are covered with alignment films, respectively, and are opposed to each other to define a rectangular display area, and the polarizer has an absorption axis which is substantially parallel or substantially perpendicular to each of the sides of the display area.

### CROSS-REFERENCE TO RELATED APPLICATIONS

This application is based upon and claims the benefit of priority from prior Japanese Patent Application No. 2006-100026, filed Mar. 31, 2006, the entire contents of which are incorporated herein by reference.

### BACKGROUND OF THE INVENTION

1. Field of the Invention

The present invention relates generally to an optically compensated bend (OCB) mode liquid crystal display panel which is usable as a monitor of, e.g. a liquid crystal TV, a car navigation system or an information apparatus, and more particularly to an OCB mode liquid crystal display panel which may be situated in a special environment due to, e.g. mounting on a car.

2. Description of the Related Art

In general, conventional liquid crystal display panels are of a TN mode. In recent years, particular attention has been paid to an OCB mode liquid crystal display panel as a liquid crystal display device which is suited to moving image display because the OCB mode liquid crystal display panel has a higher liquid crystal responsivity than the TN mode liquid crystal display panel (see IEICE Technical Report, EDI98-144, p. 199) A typical OCB mode liquid crystal display panel is configured such that a liquid crystal layer is held between first and second electrode substrates, and a pair of polarizers are attached to the first and second electrode substrates via optical retardation plates. The first and second electrode substrates have, on the liquid crystal layer side, electrodes which are covered with alignment films. Before supply of power, the liquid crystal layer is in a state that liquid crystal molecules are aligned in a splay alignment, as shown in FIG. 11. Thus, after supply of power, it is necessary that initialization is performed in advance to transition the liquid crystal molecules to a bend alignment which enables a display operation. In the initialization, a relatively large liquid crystal drive voltage, for example, of about 25V is applied between the electrodes of the first and second electrode substrates as a transition voltage for transitioning the splay alignment to the bend alignment.

In the prior art, a relationship shown in FIG. 12 is established between the absorption axes of the paired polarizers and the rubbing directions of the alignment films on the first and second electrode substrates. Specifically, the rubbing directions of the alignment films are set in alignment with the vertical direction (up-and-down direction) of a rectangular display area, and the absorption axes of the paired polarizers are set at 45° with respect to the rubbing directions in a cross-Nicol fashion (see Jpn. Pat. Appln. KOKAI Publication No. 2002-116444). Thereby, a luminance distribution characteristic shown in FIG. 13 is obtainable at a time of white display. This luminance distribution characteristic is preferred as being suited to liquid crystal TVs which should be bright in the horizontal direction (right-and-left direction) of the display area. Further, there is another example in which the rubbing directions of the alignment films on the paired electrode substrates are set in alignment with the horizontal direction of the display area (see Jpn. Pat. Appln. KOKAI Publication No. 07-084254). With the relationship of FIG. 12, which is established between the rubbing directions and absorption axes, asymmetry in black display occurs in the horizontal direction of the display area, which is perpendicular to the rubbing directions. Thus, by setting the rubbing directions in alignment with the horizontal direction of the display area, symmetry in black display is obtained in the horizontal direction of the display area. This causes the asymmetry in black display to occur in the vertical direction of the display area. In the meantime, the problem of the asymmetry in black display can be solved by a technique which was proposed later than Jpn. Pat. Appln. KOKAI Publication No. 07-084254 (see Jpn. Pat. Appln. KOKAI Publication No. 11-271759).

The inventor's study has revealed that non-uniformity in display occurs if an OCB mode liquid crystal display panel, in which the rubbing directions and absorption axes have the relationship shown in FIG. 12, is left for about 100 hours in a high-temperature environment. At a time of black display, whitish portions appear in the vicinity of four sides, i.e. upper, lower, right and left sides of the display area, as shown in FIG. 14. In addition, at a time of gray display, blackish portions appear in the vicinity of two sides, i.e. upper and lower sides of the display area, and whitish portions appear in the vicinity of two sides, i.e. right and left sides of the display area, as shown in FIG. 15. Such non-uniformity in display occurs, not only by leaving the OCB mode liquid crystal display panel in the high-temperature environment for a long time, but also by leaving the OCB mode liquid crystal display panel in a high-humidity environment for a long time or leaving it in an environment in which a rapid temperature change occurs.

### BRIEF SUMMARY OF THE INVENTION

An object of the present invention is to provide a liquid crystal display panel which can reduce non-uniformity in display, which occurs depending on environments relating to temperatures and humidity.

According to the invention, there is provided a liquid crystal display panel comprising: first and second electrode substrates; a liquid crystal layer which is held between the first and second electrode substrates and contains liquid crystal molecules whose alignment state is capable of transitioning to a bend alignment for enabling a display operation; a retardation plate disposed at least on the first electrode substrate; and a polarizer disposed on the retardation plate, wherein the first and second electrode substrates include a pair of electrodes which -are covered with alignment films, and are opposed to each other to define a rectangular display area, and the polarizer has an absorption axis substantially parallel or substantially perpendicular to each of the sides of the display area.

According to the inventor's study, in the case where the absorption axis of the polarizer is present in the direction shown in FIG. 12, retardation of the retardation plate indicated by arrows in FIG. 15 becomes a factor of non-uniformity in display that occurs depending on the environment relating to temperatures and humidity. If the liquid crystal display panel is exposed to high temperatures for a long time, moisture in the polarizer is diffused out to produce compressive stress in the polarizer. On the other hand, since the polarizer, together with the retardation plate, is attached to each of the first and second electrode substrates, a restrictive force, which does not allow easy deformation, acts on the polarizer. This restrictive force, however, is relatively weak in the vicinity of peripheral edges of the electrode substrate, and thus the stress can be relaxed. Accordingly, the stress occurring in the polarizer is distributed as shown in FIG. 16. At the central part, the stress is not relaxed and is isotropical. At the corners, the stress is relaxed. At a central part of each side, the stress in a direction perpendicular to the side is relaxed, but the stress in a direction parallel to the side is not relaxed. Due to this stress, undesired birefringence and retardation occur. The undesired retardation does not occur if the stress is isotropical. However, if the stress is an isotropical, the undesired retardation occurs, and is distributed as shown in FIG. 17. At the part where the undesired retardation occurs, a TAC (triacetyl cellulose) layer is extended by the compression stress of the polarizer and birefringence occurs. The inventor of the present invention has found that the distribution pattern of the above undesired retardation depends on the cut-out shape of the polarizer.

In the case where the undesired retardation occurs as described above, if the absorption axis of the polarizer is set in the direction shown in FIG. 12, the transmittance increases with respect to the retardation in the direction at 45° to the absorption axis, leading to non-uniformity in display in the vicinity of the four sides of the display area.

In addition, the retardation occurs not only in the case where the liquid crystal display panel is left in the high-temperature environment for a long time, but also in the case where the liquid crystal display panel undergoes a rapid temperature change. Specifically, the polarizer has a greater expansion coefficient than the glass substrate which is generally used as a member for supporting electrodes in the first and second electrode substrates. Thus, an internal stress occurs in the polarizer due to expansion or contraction due to a rapid change in temperature, and this leads to similar non-uniformity in display. In the case of effecting gray display, for instance, at the time of expansion, the display area becomes blackish in the vicinity of two sides, i.e. upper and lower sides, and becomes whitish in the vicinity of two sides, i.e. right and left sides, as shown in FIG. 15. By contrast, at the time of contraction, the display area becomes whitish in the vicinity of two sides, i.e. upper and lower sides, and becomes blackish in the vicinity of two sides, i.e. right and left sides.

Furthermore, in the case where the liquid crystal display panel is left in the high-humidity environment for a long time, the polarizer expands due to humidity, leading to similar non-uniformity in display. In this case, the display area becomes whitish in the vicinity of two sides, i.e. upper and lower sides, and becomes blackish in the vicinity of two sides, i.e. right and left sides.

In the meantime, in many cases, even if the non-uniformity in display occurs, the stress is totally relaxed by further leaving in the environment and the non-uniformity disappears. However, this relaxation of stress requires several hours to several weeks.

In the liquid crystal display panel of the present invention, the polarizer has the absorption axis which is not at 45°, but is substantially parallel or substantially perpendicular, to the sides of the display area, which are parallel to the cut-out sides of the polarizer. In general, in the cross-Nicol system, retardation in the absorption-axis direction does not optically appear. Thus, even if an undesired retardation distribution is present depending on the environment relating to temperatures and humidity, the non-uniformity in display can be reduced by setting the absorption axis of the polarizer in alignment with the direction of the retardation.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows the circuit configuration of a liquid crystal display device according to an embodiment of the present invention;

FIG. 2 schematically shows a general appearance of a liquid crystal display panel shown in FIG. 1;

FIG. 3 shows a cross-sectional structure of the liquid crystal display panel shown in FIG. 1 and FIG. 2;

FIG. 4 shows the arrangement of absorption axes of upper and lower polarizers shown in FIG. 3;

FIG. 5 shows non-uniformity in display occurring in the vicinity of corners of a display area shown in FIG. 1;

FIG. 6 shows a luminance distribution characteristic which is obtained at a time of white display by the setting of absorption axes shown in FIG. 4;

FIG. 7 is a view for explaining the impression of brightness obtained when the liquid crystal display panel shown in FIG. 1, which is mounted on a vehicle, is viewed from an upper left side and an upper right side;

FIG. 8 schematically illustrates a method of fabricating a glass plate shown in FIG. 2;

FIG. 9 is a conceptual view showing a non-uniform state of transmissive light in a case where absorption axes of polarizers are disposed at 45° with respect to the sides of a glass plate, and the glass plate is disposed between the polarizers;

FIG. 10 is a conceptual view showing a non-uniform state of transmissive light in a case where absorption axes of polarizers are disposed substantially parallel or perpendicular to the sides of a glass plate, and the glass plate is disposed between the polarizers;

FIG. 11 shows the alignment state of liquid crystal molecules which is transitioned from a splay alignment to a bend alignment in order to execute a display operation in an OCB mode liquid crystal display panel;

FIG. 12 shows a relationship between rubbing directions of alignment films and absorption axes of polarizers, which is adopted in a conventional OCB mode liquid crystal display panel;

FIG. 13 shows a luminance distribution characteristic which is obtained at a time of white display in the liquid crystal display panel, which has been described with reference to FIG. 12;

FIG. 14 shows non-uniformity in display occurring at a time of black display in a case where the liquid crystal display panel, which has been described with reference to FIG. 12, is left in a high-temperature environment for a long time;

FIG. 15 shows non-uniformity in display occurring at a time of white display in a case where the liquid crystal display panel, which has been described with reference to FIG. 12, is left in a high-temperature environment for a long time;

FIG. 16 shows a distribution of stress occurring in a polarizer in a case where the liquid crystal display panel, which has been described with reference to FIG. 12, is left in a high-temperature environment for a long time; and

FIG. 17 shows a distribution of retardation occurring due to the distribution of stress shown in FIG. 16.

### DETAILED DESCRIPTION OF THE INVENTION

A liquid crystal display device according to an embodiment of the present invention will now be described with reference to the accompanying drawings.

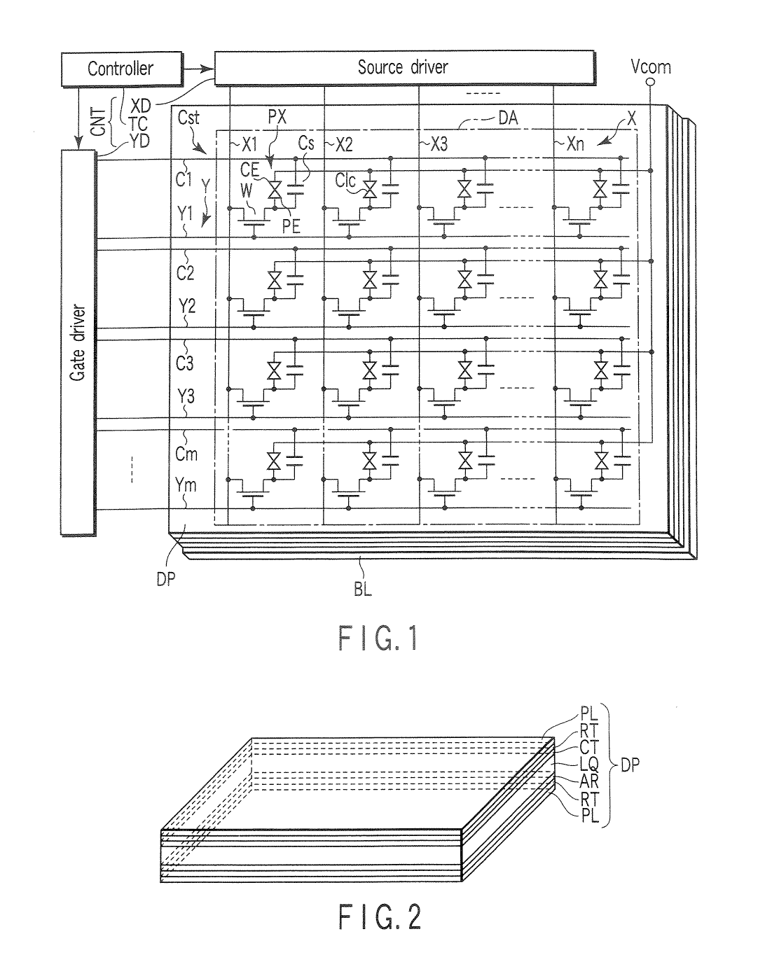

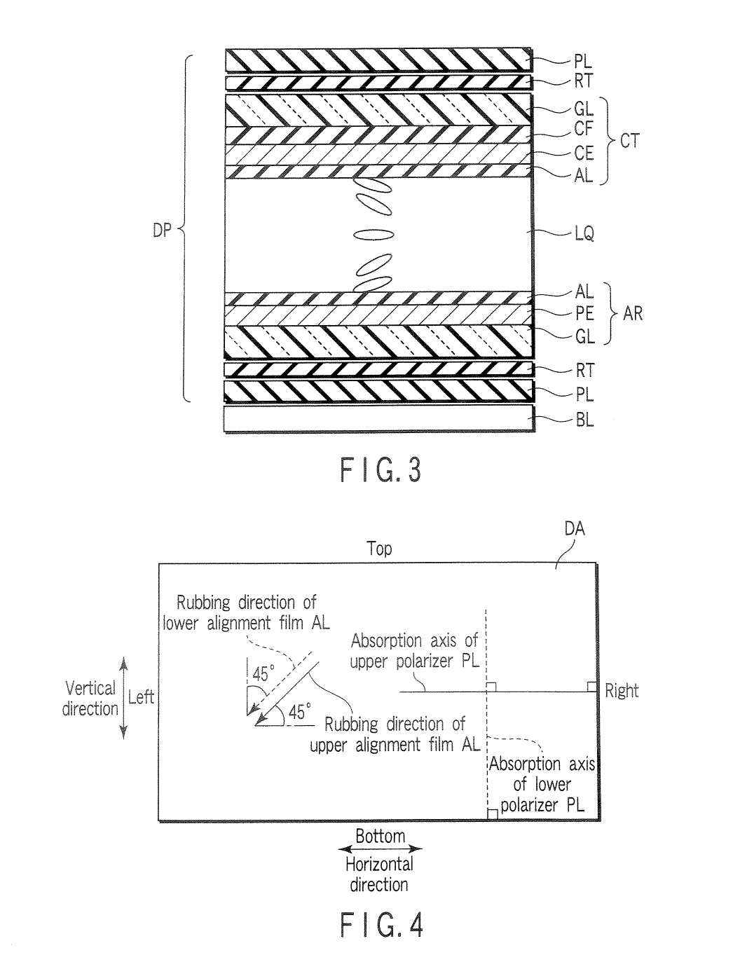

FIG. 1 shows the circuit configuration of the liquid crystal display device. FIG. 2 schematically shows a general appearance of an OCB mode liquid crystal display panel DP shown in FIG. 1. FIG. 3 shows a cross-sectional structure of the liquid crystal display panel DP shown in FIG. 2. The liquid crystal display device is usable as a monitor of, e.g. a liquid crystal TV, a car navigation system or an information apparatus. In this embodiment, the liquid crystal display panel DP is suited for the liquid crystal TV, and includes a display area DA having a diagonal size of 32 inches, for example. The liquid crystal display device, as shown in FIG. 1, includes an OCB mode liquid crystal display panel DP in which a plurality of OCB liquid crystal pixels PX are arrayed substantially in a matrix, a backlight BL which illuminates the liquid crystal display panel DP, and a display control circuit CNT which controls the liquid crystal display panel DP.

The liquid crystal display panel DP, as shown in FIG. 2, includes an array substrate AR, a counter-substrate CT, a liquid crystal layer LQ held between the array substrate AR and counter-substrate CT, a pair of retardation plates RT which are disposed on the array substrate AR and counter-substrate CT, and a pair of polarizers PL which are disposed on the retardation plates RT. The array substrate AR and counter-substrate CT are electrode substrates which are opposed to each other via the liquid crystal layer LQ.

As shown in FIG. 3, the array substrate AR includes a glass plate GL provided as a transparent insulating substrate, a plurality of pixel electrodes PE formed on the glass substrate GL, and an alignment film AL covering the pixel electrodes PE. The counter-substrate CT includes a glass substrate GL provided as a transparent insulating substrate, a color filter layer CF formed on the glass substrate GL, a common electrode CE formed on the color filter layer CF, and an alignment film AL covering the common electrode CE. The liquid crystal layer LQ is obtained by filling a liquid crystal material in a gap between the counter-substrate CT and array substrate AR. The color filter layer CF includes a red-colored layer for a red pixel, a green-colored layer for a green pixel, a blue-colored layer for a blue pixel, and a black-colored (light-shield) layer for a black matrix. The backlight BL is disposed, as a light source, on the outside of the polarizer PL provided for the array substrate AR.

In the array substrate AR, the pixel electrodes PE are arrayed substantially in a matrix on the glass plate GL, and the pixel electrodes PE are opposed to the common electrode CE so as to define a rectangular display area (display screen) DA. In addition, as shown in FIG. 1, a plurality of gate lines Y (Y1 to Ym) and a plurality of storage capacitor lines Cst (C1 to Cm) are arranged along the rows of pixel electrodes PE, and a plurality of source lines X (X1 to Xn) are arranged along the columns of pixel electrodes PE. A plurality of pixel switching elements W are disposed near intersections of the gate lines Y and source lines X. Each of the pixel switching elements W is composed of a thin-film transistor having a gate connected to the associated gate line Y, and a source-drain path connected between the associated source line X and the associated pixel electrode PE. The pixel switching element W is driven via the associated gate line Y to be made conductive between the associated source line X and associated pixel electrode PE.

Each of the OCB liquid crystal pixel PX is composed of the associated pixel electrode PE, the common electrode CE, and a pixel region which is a part of the liquid crystal layer LQ that is disposed between the electrodes PE and CE. Each OCB liquid crystal pixel PX has a liquid crystal capacitance Clc which holds a potential difference between the pixel electrode PE and common electrode CE as a liquid crystal drive voltage. Each of the storage capacitor lines Cst (C1 to Cm) is set at a potential equal to, e.g. a potential of the common electrode CE. Each storage capacitance line Cst is capacitive-coupled to the pixel electrodes PE of the liquid crystal pixels PX of the associated row, thereby constituting storage capacitances Cs. In each OCB liquid crystal pixel PX, liquid crystal molecules are aligned in a splay alignment that disables a display operation, before supply of power. After supply of power, the alignment state thereof is transitioned to a bend alignment that enables the display operation.

The display control circuit CNT includes a gate driver YD which sequentially drives the gate lines Y so as to turn on the switching elements W on a row-by-row basis, a source driver XD which outputs pixel voltages Vs to the source lines X for a period in which the switching elements W of each row are turned on by the driving of the associated gate line Y, and a controller TC which controls the gate driver YD and source driver XD. The display control circuit CNT is configured to initialize, immediately after supply of power, the OCB liquid crystal pixels PX so as to transition, in advance, the alignment state of liquid crystal molecules from the splay alignment to the bend alignment, and also configured to enable, after the initialization, the OCB liquid crystal pixels PX to perform the display operation. In the initialization of each OCB liquid crystal pixel PX, a transition voltage of a predetermined transition pattern is output as a common voltage Vcom to the common electrode CE, for example. Thereby, the liquid crystal drive voltage between the pixel electrodes PE and common electrode CE is set to be greater than a drive voltage at a normal display time, and thus the alignment state of liquid crystal molecules is transitioned to the bend alignment. After the transition, the transmittance of each OCB liquid crystal pixel PX is controlled by the liquid crystal drive voltage between the pixel electrodes PE and common electrode CE.

After supply of power, the controller TC internally generates a vertical timing control signal, a horizontal timing control signal and pixel data in order to initialize the OCB liquid crystal pixels PX until a display signal and a sync signal, which are supplied from outside, become stable. In addition, in order to perform a display operation after the initialization, the controller TC generates a vertical timing control signal and a horizontal timing control signal on the basis of the sync signal, and generates pixel data on the basis of the display signal. The vertical timing control signal is output to the gate driver YD, and the horizontal timing control signal and pixel data are output to the source driver XD. The gate driver YD sequentially selects the gate lines Y under the control of the vertical timing control signal, and outputs to the selected gate line Y a gate driving voltage for turning on the pixel switching elements W for one row. The source driver XD, under the control of the horizontal timing control signal, converts pixel data for one row to pixel voltages Vs and outputs the pixel voltages Vs to the source lines X in a parallel fashion while the gate driving voltage is being output to the selected gate line Y.

In the above-described liquid crystal display panel DP, the alignment film AL on the array substrate AR side (i.e. lower side) and the alignment film AL on the counter-substrate CT side (i.e. upper side) are subjected to rubbing treatment in mutually parallel directions, as shown in FIG. 4. The rubbing direction of these alignment films AL is set at 45° to each side of the display area DA. On the other hand, each of the polarizer PL on the array substrate AR side (i.e. lower side) and the polarizer PL on the counter-substrate CT side (i.e. upper side) has a rectangular shape with four sides (cut-out sides) which are parallel to the four sides of the display area DA. The absorption axes of the polarizers PL are set in a cross-Nicol fashion with an angle of 45° to the rubbing direction of each alignment film AL. Specifically, the upper polarizer PL and lower polarizer PL have absorption axes which are substantially parallel or perpendicular to the sides of the display area DA. In addition, on the array substrate AR side (i.e. lower side) and counter-substrate CT side (i.e. upper side), each retardation plate RT is configured to include a stress-relaxing adhesive layer which attaches the associated polarizer PL to the associated glass plate GL.

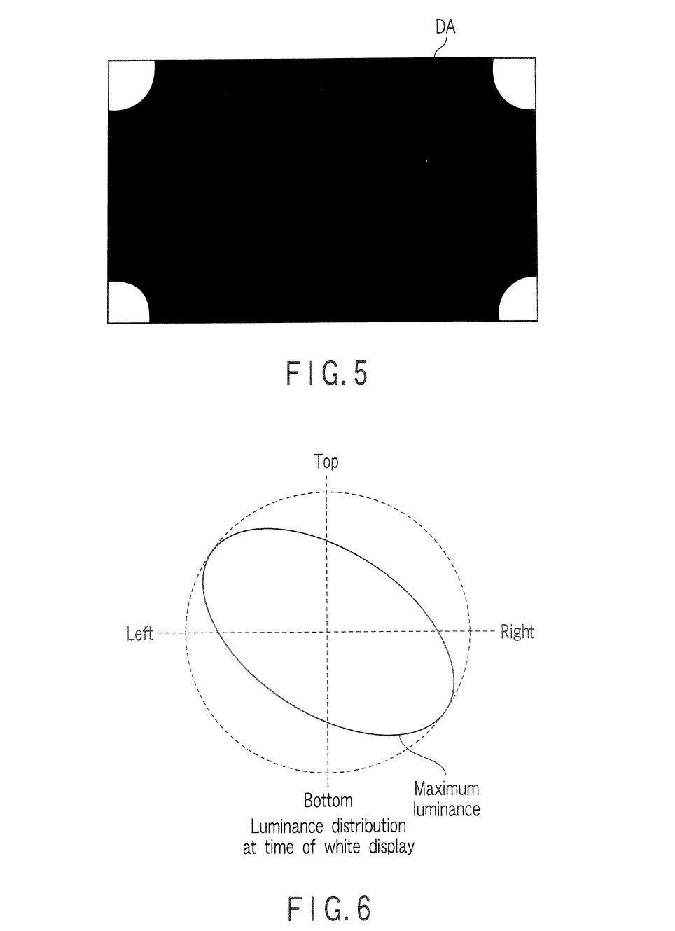

In the present embodiment, each polarizer PL has the absorption axis which is substantially parallel or perpendicular to that side of the display area DA, which is parallel to the cut-out side of the polarizer PL. In general, in the cross-Nicol system, retardation in the absorption-axis direction does not appear optically. Thus, even if undesired retardation is present depending on an environment relating to temperatures or humidity, non-uniformity in display can be reduced by setting the absorption axis of the polarizer pl in alignment with the direction of the retardation. Besides, such non-uniformity, even if it occurs, appears only in the vicinity of the corners of the display area DA, as shown in FIG. 5. Thus, no problem arises in viewability.

In an actual experiment, even when the liquid crystal display panel DP was left in an environment at 85°, no non-uniformity in display occurred. In the meantime, a conspicuous non-uniformity in display occurs if the conventional liquid crystal display panel having the structure shown in FIG. 12 was merely left in an environment at 60°.

Even if the liquid crystal display panel DP is abruptly cooled from normal temperature to −40° C., non-uniformity in display, which would cause a serious problem, does not occur. In the embodiment, the liquid crystal display panel DP is applied to a liquid crystal TV which has a diagonal size, for example, of 9 inches or more and requires excellent viewability for a large display area. In particular, such a requirement is strict in a liquid crystal display having a diagonal size of 15 inches or more. In addition, this liquid crystal display panel DP is optimally applicable to a car-mounted display which requires a normal operation in a wide temperature range.

In the liquid crystal display panel DP, at the time of white display, the luminance is high in an oblique direction of the display area DA, for example, as shown in FIG. 6, and asymmetry in luminance occurs in the horizontal direction (right-and-left direction). As a result, it is possible to obtain a situation where a dark impression is made when the display area DA is viewed from upper right, and a bright impression is made when the display area DA is viewed from upper left.

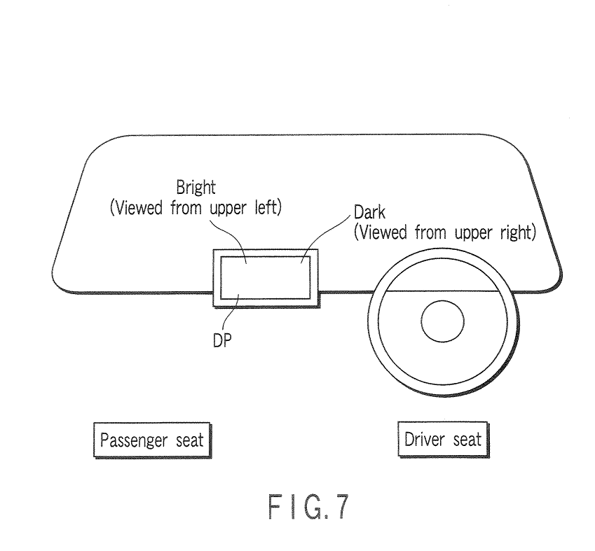

For example, when the liquid crystal display panel DP is applied to a car-mounted display, for which leak light to the driver is a problem, the above-mentioned feature can be made use of in order to ensure safe driving. Specifically, in usual cases, the liquid crystal display panel DP is attached near a central position of the dashboard, as shown in FIG. 7, and the liquid crystal display panel DP falls within the field of view of the driver who drives while viewing the front. Consequently, leak light from the display area DA due to non-uniformity in display may tend to hinder the driving. However, the luminance of leak light can be decreased by adopting such a luminance distribution characteristic that the display area DA looks dark in white display when the display area AD is viewed from one of an upper right side and an upper left side, which corresponds to the position of the driver. This is particularly effective for the OCB mode liquid crystal display panel DP having a wide viewing angle.

Each of the polarizers PL has a rectangular shape with four sides which are parallel to the four sides of the display area DA. It is also significant that each of the array substrate AR and counter-substrate CT has four sides which are parallel to the four sides of the display area DA. In each of the substrates AR and CT, the glass plate GL (transparent insulating substrate) is employed as an electrode support member. Since the polarizers PL have absorption axes which are substantially parallel or perpendicular to the sides of the display area DP, the absorption axes of the polarizers PL are also set to be substantially parallel or perpendicular to the four sides (cut-out sides) of the lass plate GL. Therefore, the liquid crystal display panel DP can reduce not only non-uniformity in display due to expansion or compressive stress of the polarizer PL, but also non-uniformity in display due to retardation inherent to the glass plate GL.

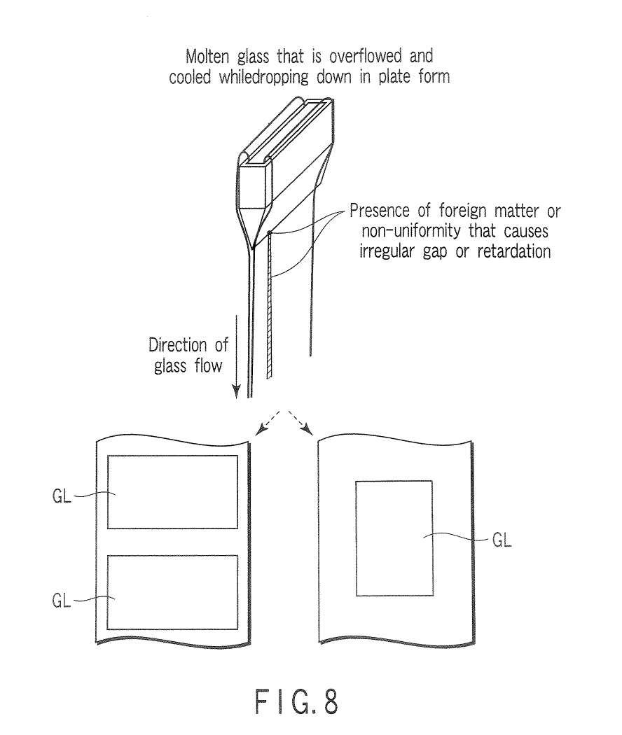

FIG. 8 schematically illustrates a fabrication method of the glass plate GL. As shown in FIG. 8, glass in a molten state is overflowed from both sides of a container, and the overflown molten glass portions are made confluent at a distal end of a lower taper portion of the container and are let to flow downward. The molten glass is cooled while it is moving in the direction of glass flow. As a result, a glass plate with a width corresponding to the width of the container is formed. In this case, if the molten glass is non-uniformly cooled or slight asperities occur due to foreign matter or the like adhering to the surface of the container, this leads to an internal stress and the plate-shaped glass has undesired retardation depending on the internal stress. Considerable retardation components exist in directions parallel or perpendicular to the direction of flow of the molten glass.

Since the glass plate GL is normally used in a rectangular shape, to be more specific, a rectangle, the glass plate GL is cut out from the plate-shaped glass in a direction parallel or perpendicular to the direction of glass flow. As a result, retardation frequently occurs in directions parallel or perpendicular to the sides of the cut-out glass plate GL. If the absorption axis of the polarizer PL is set as shown in FIG. 12, this may provide a situation where the transmittance increases with respect to the retardation of the glass plate GL in the direction at 45° to this absorption axis, and non-uniformity in display occurs in the vicinity of the four sides of the display area DP.

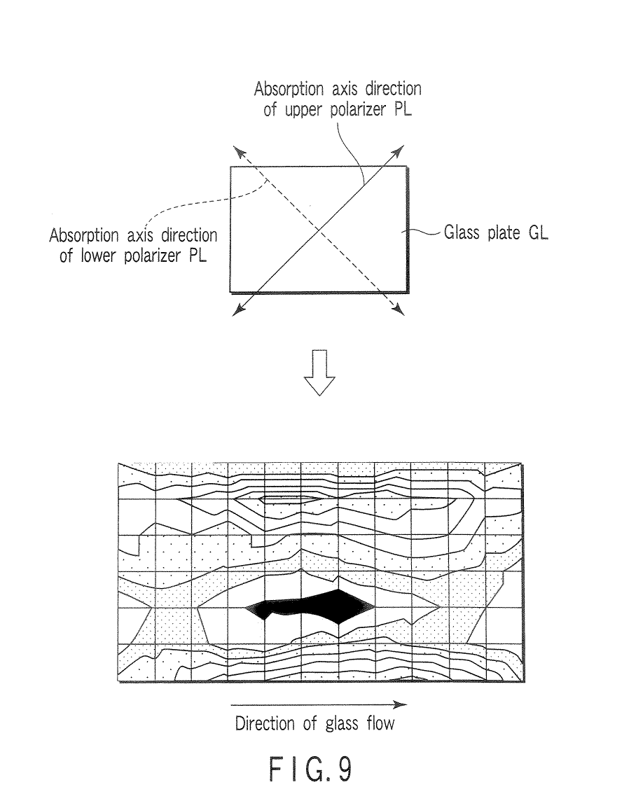

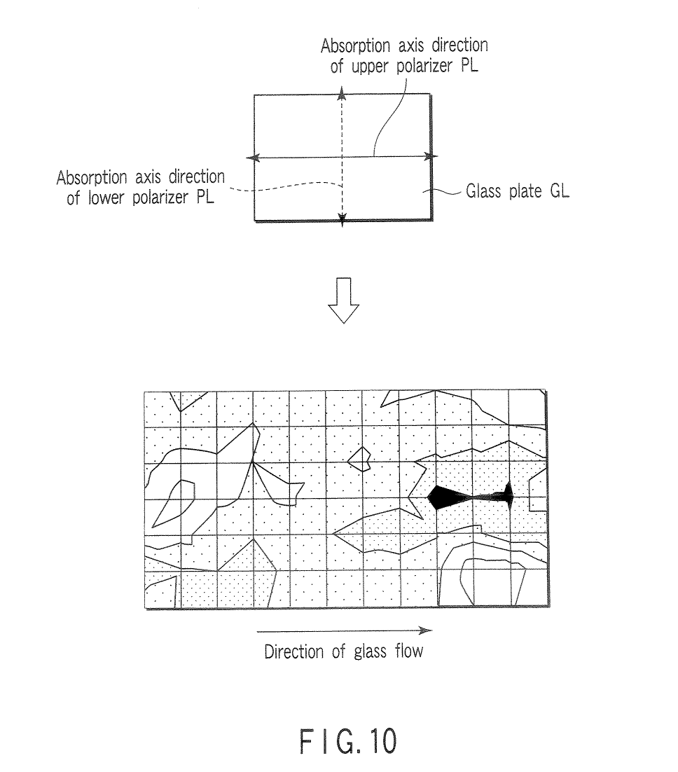

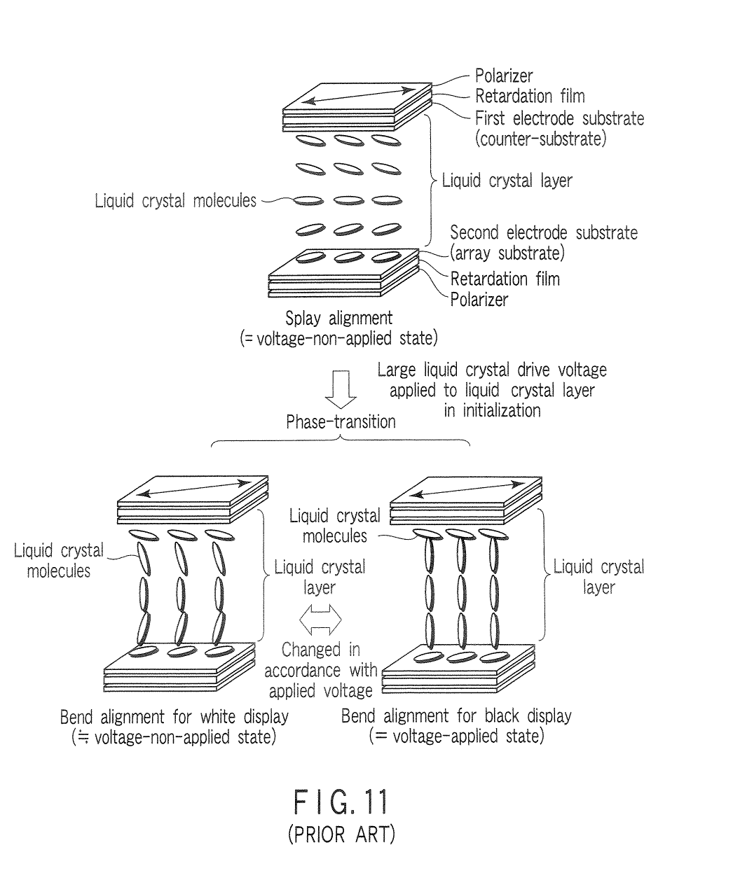

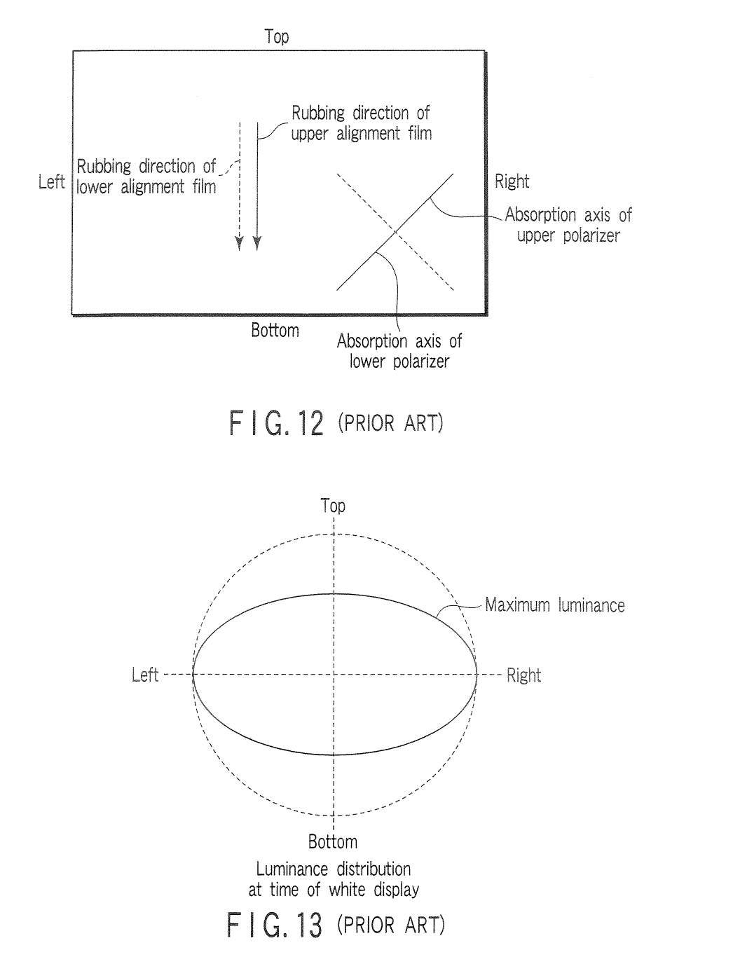

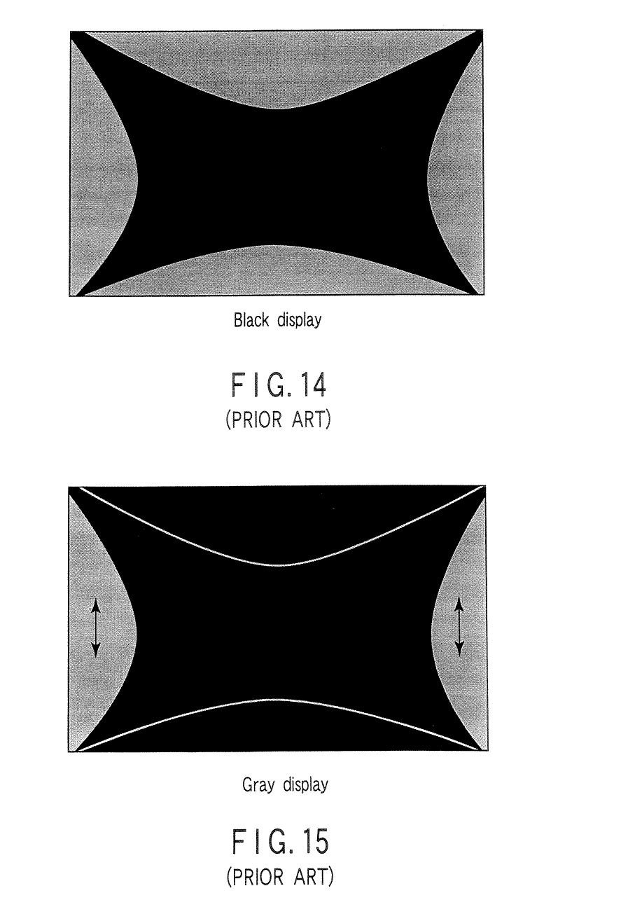

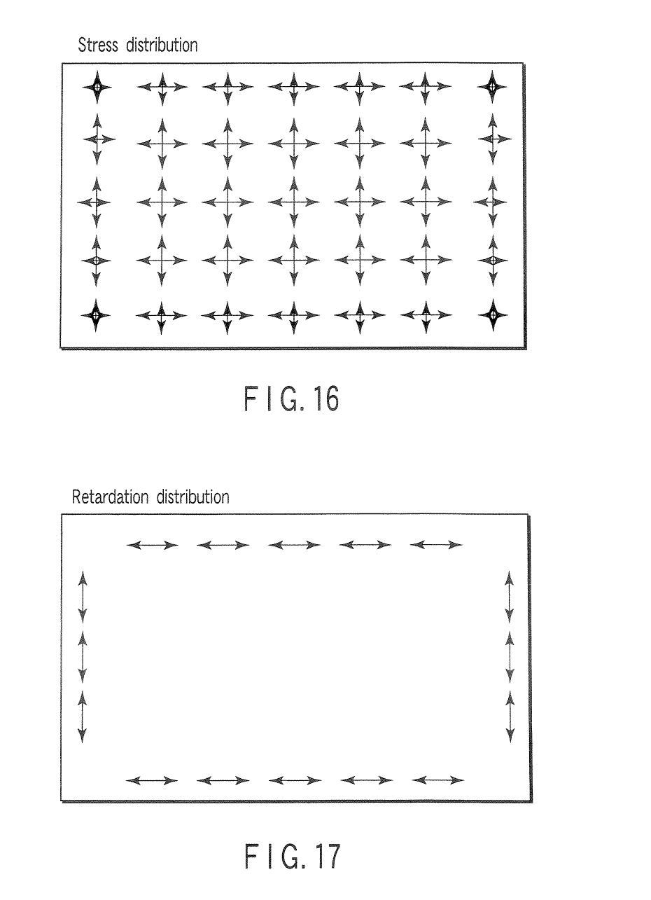

FIG. 9 is a conceptual view showing a non-uniform state of transmissive light in a case where the absorption axes of the two polarizers PL are set at 45° to the four sides of the glass plate GL in a cross-Nicol fashion, and the glass plate GL is disposed between the polarizers PL. On the other hand, in the present embodiment, the absorption axes of the polarizers PL are also set to be parallel or perpendicular to the four sides (cut-out sides) of the glass plate GL, as shown in FIG. 4. Thus, the non-uniformity in display due to the retardation inherent to the glass plate GL can also be reduced. FIG. 10 is a conceptual view showing a non-uniform state of transmissive light in a case where the absorption axes of the two polarizers PL are set to be parallel or perpendicular to the sides of the glass plate GL in a cross-Nicol fashion, and the glass plate GL is disposed between the two polarizers PL.

Although each of the polarizers PL has a rectangular shape with four sides which are parallel to the four sides of the display area DA, it is also significant that each of the array substrate AR and counter-substrate CT is so set by the display operation as to have a temperature distribution inclined in a direction parallel to any one of the four sides of the display area DA. For example, when a temperature difference is imparted to the glass plate GL, retardation occurs in the inclination direction of the temperature distribution. This temperature difference depends greatly on the backlight BL which is turned on in the display operation of the liquid crystal display panel DP. Whether the backlight BL is a just-under-panel type backlight or a side-light type backlight, the inclination direction of the temperature distribution is set to be parallel to any one of the four sides (cut-out sides) of the glass plate GL. Since the polarizer PL has the absorption axis which is substantially parallel or substantially perpendicular to each side of the display area DP, the absorption axis of the polarizer PL is set to be substantially parallel or substantially perpendicular to the inclination direction of the temperature distribution, which is commonly set for the array substrate AR and counter-substrate CT. Therefore, the liquid crystal display panel DP can reduce not only the non-uniformity in display due to the retardation inherent to the glass plate GL, but also the non-uniformity due to the inclination of the temperature distribution.

The present invention is not limited to the above-described embodiment, and various modifications can be made without departing from the spirit of the invention.

The present invention is applicable to the liquid crystal display panel DP regardless of the size of the display area DA, but a greater advantageous effect is expectable as the size of the display area DA becomes larger. If the size of the liquid crystal display panel DP is large, the relaxation of stress is slow and non-uniformity in display tends to remain for a very long time. By contrast, if the liquid crystal display panel DP is small, the relaxation of stress is quick and a problem in operation hardly occurs. Therefore, with taking the viewability into consideration, it is preferable, in practice, to apply the present invention to the liquid crystal display panel DP in which the display area DA has a size of 9 inches or more in each diagonal direction. Moreover, if the present invention is applied to the liquid crystal display panel DP in which the display area DA has a size of 15 inches or more in each diagonal direction, the advantageous effect of the invention becomes conspicuous.

In the above-described embodiment, the present invention has been applied to the transmissive liquid crystal display panel DP. Alternatively, the invention may be applied to a reflective or transflective liquid crystal display panel, which performs display by using ambient light.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display panel comprising:
first and second electrode substrates;
a liquid crystal layer which is held between said first and second electrode substrates and contains liquid crystal molecules whose alignment state is capable of transitioning to a bend alignment for enabling a display operation;
a retardation plate disposed at least on said first electrode substrate; and
a polarizer disposed on the retardation plate,
wherein said first and second electrode substrates include a pair of electrodes which are covered with alignment films, and are opposed to each other to define a rectangular display area, and said polarizer has an absorption axis substantially parallel or substantially perpendicular to each of the sides of said display area.

2. The liquid crystal display panel according to claim 1, wherein said polarizer is of a rectangular shape having four sides which are parallel to the four sides of said display area.

3. The liquid crystal display panel according to claim 1, wherein said first electrode substrate is of a rectangular shape having four sides which are parallel to the four sides of said display area.

4. The liquid crystal display panel according to claim 1, wherein said first electrode substrate is set by the display operation to have a temperature distribution inclined in a direction which is parallel to any one of the four sides of said display area.

5. The liquid crystal display panel according to claim 1, wherein said display area has a luminance distribution characteristic that said display area looks dark in white display when said display area is viewed from one of an upper right side and an upper left side.

6. The liquid crystal display panel according to claim 1, wherein said display area has a size of 9 inches or more in each of diagonal directions.

7. The liquid crystal display panel according to claim 1, wherein said display area has a size of 15 inches or more in each of diagonal directions.

8. The liquid crystal display panel according to claim 1, wherein said retardation plate includes a stress-relaxing adhesive layer which attaches said polarizer to said first electrode substrate.
